(19) United States
(12) Patent Application Publication
(10) Pub. No.: US 2003/0066321 A1
(43) Pub. Date: Apr. 10, 2003

(54) LOCKSET KEYWAY COVER-UP MECHANISM

(76) Inventor: Liang-Chin Su, Kaohsiung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/971,724

(22) Filed: Oct. 9, 2001

(51) Int. Cl. E05B 47/00

(52) U.S. Cl. 70/276

(57) ABSTRACT

A lockset keyway cover-up mechanism is composed of a rotor, a retainer, a bushing, magnetic pins and springs adapted with a key, which is provided with an unlocking part containing multiples of magnets, characterized by that the keyway and multiples of pinholes to accommodate the springs and those magnetic pins are directly or with a rotor case cover provided on the front end of the rotor; multiples of insertion holes are provided in recess on the retainer so that the retainer holds against the end of the rotor by means of the bushing and those insertion holes of the retainer are held in position by the insertion of those magnetic pins protruding from the front face of the rotor for the through hole of the retainer to be at a location apart from the keyway, which in turn is covered up.

### BACKGROUND OF THE INVENTION

(a) Field of the Invention

The present invention is related to a lockset keyway cover-up mechanism to prevent ingression by dust or other foreign matters into the keyway, and more particularly, to one that has magnetic pins and a retainer either made integrated with or separately mounted to the front face of the keyway, said retainer relatively rotates with the rotor and is locked up to effectively cover up the keyway, and is unlocked by taking advantage of the rejection force created by two opposite magnetic poles.

(b) Description of the Prior Art

The prior art as taught in Japanese Patent No. JP11044132 essentially has provided multiples of irregular holes on the front face of the rotor to accommodate corresponding magnetic pins mounted together with cover plate, retainer and bonnet on the front end of the rotor. Circumference of the retainer is provided with retaining walls and pushed against by spring to constantly maintain upward elasticity; through holes and perforates are provided on the bonnet, and multiples of magnetic pieces are provided to the head of the key. Said through holes are covered up as the keyway is always covered up due to that the retainer being restricted by those pins are prevented from moving upward; meanwhile said perforates on the bonnet is also closed as restricted by the cover plate. Upon unlocking, said magnetic pieces from the key is pressed against the cover plate inside the perforates and those pins are rejected by those magnetic pieces having opposite magnetic poles and retreat to clear away from said retaining walls to allow said retainer move upward by elasticity from the spring to expose the keyway.

The prior art operates essentially on retreating the retainer by taking advantage of the rejection force existing between those magnetic pieces on the key and pins from the front of the rotor to release the retainer from the spring for longitudinal slide without covering up the keyway. However, though serving its purpose to cover up the keyway, the structure of the prior art requires more members and higher manufacturing precision is required since the retainer relies entirely upon the spring to slide to a fixed point before the keyway is fully exposed. As a result, the assembly of the prior art is very complicate to relatively increase the production cost; it is vulnerable to failure in use; the retainer consumes extra space as it is partially exposed when released and must be pressed by the user to cover up again the keyway; and the exposed retainer threatens to cut the user.

### SUMMARY OF THE INVENTION

The primary purpose of the present invention is to provide a cover-up mechanism for a keyway of a lockset that is safer and more compact in structure with minimized failure, essentially comprised of a rotor, a retainer, a bushing, magnetic pins and springs adapted with a key containing a magnetic part to unlock. Within, a rotor case cover is directly provided on the front end of the rotor with a keyway and multiples of pinholes to accommodate springs and magnetic pins. The retainer has a through hole corresponding to the keyway and multiples of holes to receive pins protruding from the front face of the rotor for the retainer to be held in position when it is inserted by the bushing to hold against the end of the rotor. In this way, the keyway is separated from said through holes of the retainer for the keyway to be covered up. Once the unlocking part from the key attaches onto the retainer, those magnetic pins retreats due to rejection by magnetic force from and let the retainer rotate for the through hole to be overlapped over said keyway.

Another purpose of the present invention is to provide a cover-up mechanism a keyway of a lockset that gives agile operation of a key applicable to various structures of the lockset, essentially comprised of a rotator, a retainer, a bushing, magnetic pins and springs adapted with a key containing an unlocking part. An independent case cover is provided on the front end of the rotor and multiples of tab extend backward on the circumference of the bushing to restrict and from an independent unit with the retainer at the front end of the rotor case cover. Then said tabs extending from the circumference of the bushing and the rotor case cover are both inserted and fixed at the front end of the rotor.

Another purpose yet of the present invention is to provide a cover-up mechanism for a keyway of a locket by having formed a slot on the front face of an unlocking part from the key abutted to a retainer. A mating block for the slot separated from a through hole is formed on the outer side of the retainer so that the coupling by both of the mating block and the slot constitutes the only direction for the combination to achieve easy operation of the mechanism.

### BRIEF DESCRIPTION OF THE DRAWINGS

FIG. 1 is a schematic view showing a structure of a first preferred embodiment of the present invention;

FIG. 2 is a view showing an assembly of the first preferred embodiment of the present invention,

FIG. 3 is a schematic view showing the side view of a locking operation by the first preferred embodiment of the present invention;

FIG. 4 is another schematic view showing the front view of a locking operation by the first preferred embodiment of the present invention;

FIG. 5 is a schematic view showing the side view of an unlocking operation by the first preferred embodiment of the present invention;

FIG. 6 is another schematic view showing the front view of an unlocking operation by the first preferred embodiment of the present invention;

FIG. 7 is a schematic view showing a structure of an assembly of a lockset of a second preferred embodiment of the present invention;

FIG. 8 is a schematic view showing a characteristic structure of the second preferred embodiment of the present invention;

FIG. 9 is a schematic view showing that the second preferred embodiment of the present invention is in use;

FIG. 10 is another schematic view showing that the second preferred embodiment of the present invention is in use;

FIG. 11 is an exploded view of a third preferred embodiment of the present invention;

FIG. 12 is a view showing a local combination of the third preferred embodiment of the present invention; and

FIG. 13 is a schematic view showing an assembly of the third preferred embodiment of the present invention.

### DETAILED DESCRIPTION OF THE PREFERRED EMBODIMENTS

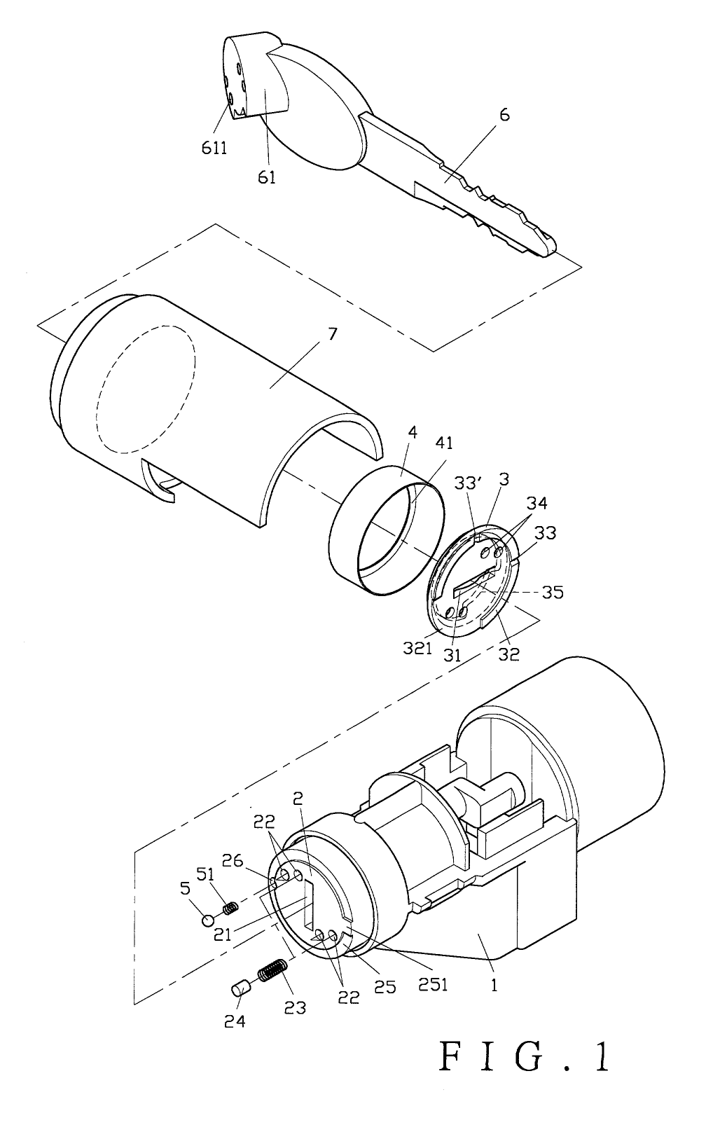

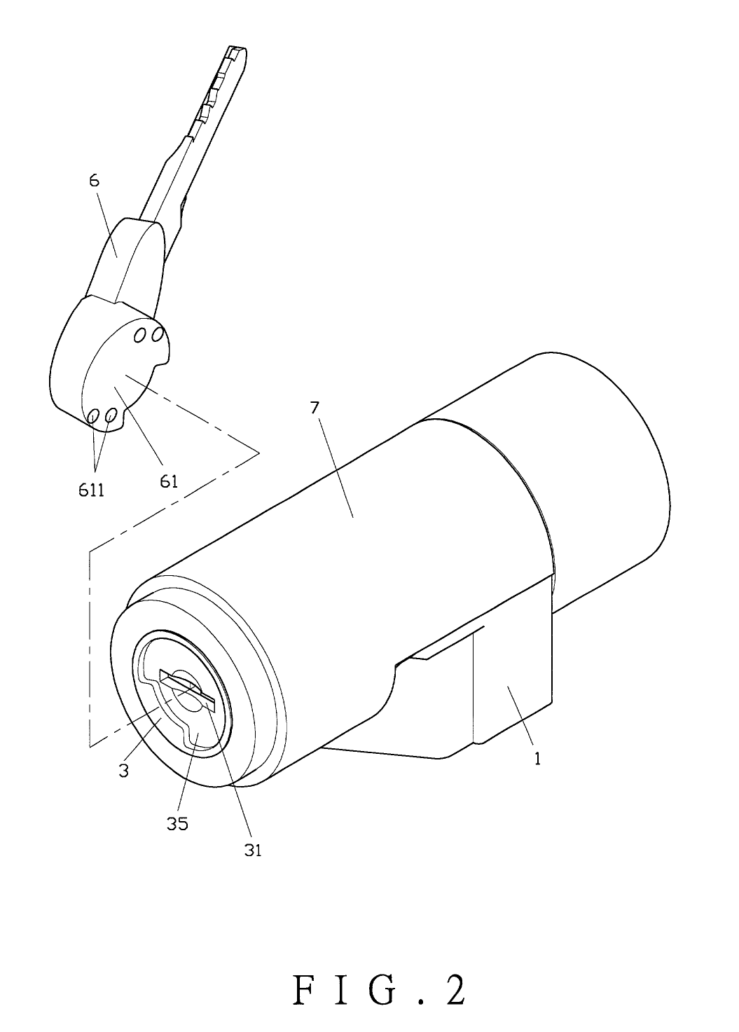

Referring to FIGS. 1 and 2, a first preferred embodiment of the present invention is essentially composed of a rotor (1), a rotor case cover (2), a retainer (3), a bushing (4), springs (23) and magnetic pins (24) adapted with a key (6). Said rotor (1) is axially provided with the rotor case cover (2). Said rotor case cover (2) has provided a keyway (21) at the center of its front face and multiples of pinholes (22) to accommodate the springs (23) and the magnetic pins (24). A guiding channel (25) is provided in recess on the circumference by the side of the rotor case cover (2), a stopper (251) and a positioning hole (26) to receive insertion by a positioning bead (5) and its spring (51).

Said retainer (3) related to an independent plate formed by compromising the shape of the rotor case cover (2) has provided a through hole (31) following the shape of the keyway (21) at its center of the front face, and a retaining wall (32) with a gap (321) is provided protruding from the circumference of its front facing the rotor case cover (2). Two slots (33) and (are provided apart from each other at a proper angle on the retaining wall (32) and multiples of insertion holes (34) are provided in recess on the surface of the retainer (3). An irregular-shaped concave (35) is provided on the other side of the retainer (3).

The bushing (4) related to a ring in a shape compromising that of the rotor case cover (2), has at the circumference of its front end formed a retaining ring (41). Multiples of locking walls may be provided to the circumference of the other end of the bushing (4) so to further secure it to the rotor case cover (2) (However, in this preferred embodiment, said bushing relates to a flush ring).

Said key (6) with a built-in unlocking part (61) containing multiples of magnet (611) at its stock. Said unlocking part (61) is formed after the shape of the concave (35) on the retainer (3) and the magnetism of those magnets (611) is the same as that of the pins (24) of said rotor case cover (2).

Said casing (7) is provided to cover up the rotor (1) and those members contained by the rotor (1).

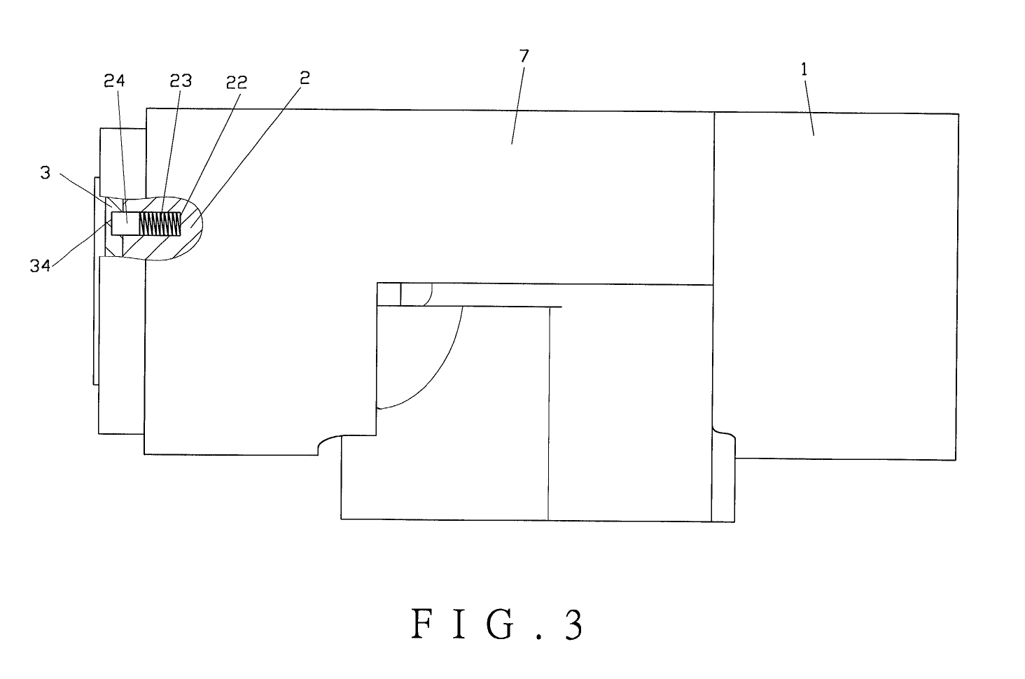

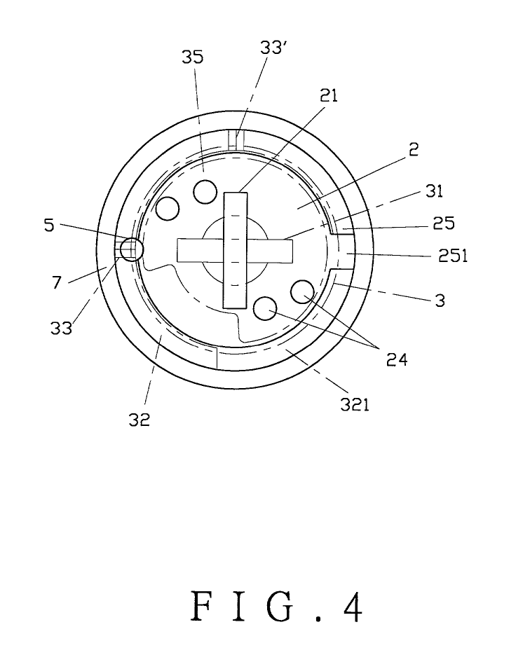

Upon assembling as illustrated in FIGS. 3 and 4, the retainer (3) is flush holding against the front end of the rotor case cover (2) with the stopper (251) of the guiding channel (25) being received in the gap (321) of the retainer (3). And the positioning bead (5) is held in position against the slot (33) on the retainer (3). The bushing (4) is inserted in relation to the rotor case cover (2) and the retainer (3). The retainer (3) and the magnetic pins (24) are held in position at the front end of the rotor case cover (2) for being subject to the retaining ring (41) of the bushing (4) to facilitate the subsequent assembling. (However, even with the absence of said bushing (4), the casing (7) is used to hold the retainer (3) against the front end of the rotor case cover (2)). The casing (7) engages the rotor (1) to cover up said members to form an integral lockset. Since said magnetic pins (24) protruding from the front face of the rotor case cover (2) are subject to the push by the springs (23), said insertion holes (34) of the retainer (3) are held in position when penetrated by said pins (24). Meanwhile the through hole (31) of the retainer (3) is apart from the keyway (21) for ninety degrees to cover up the keyway (21).

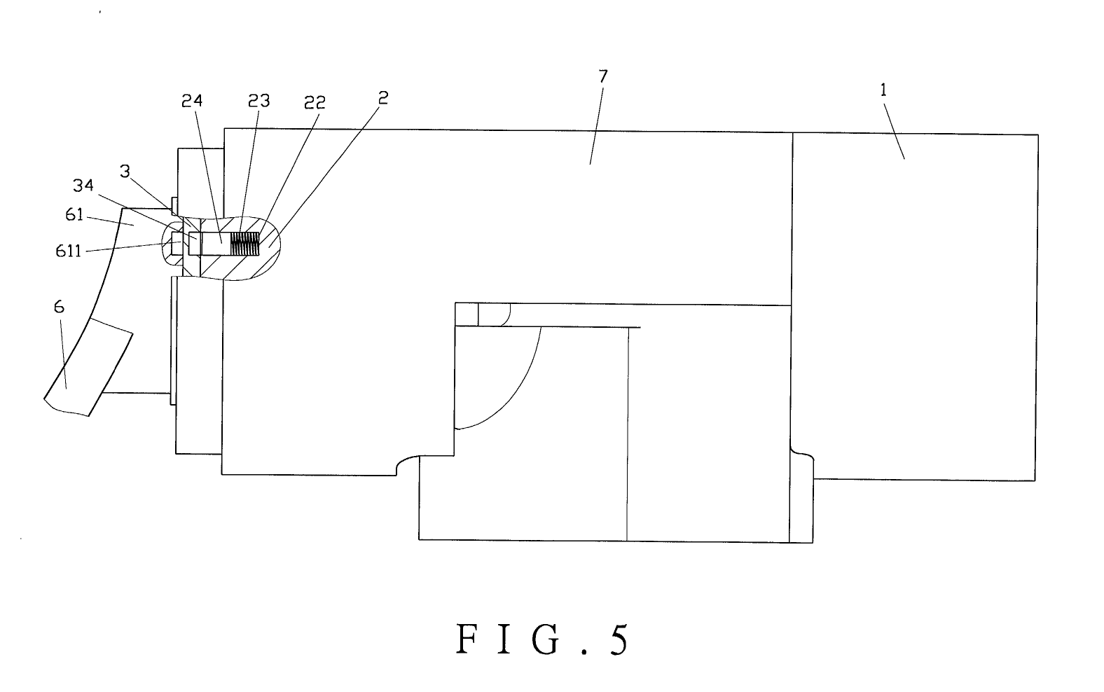

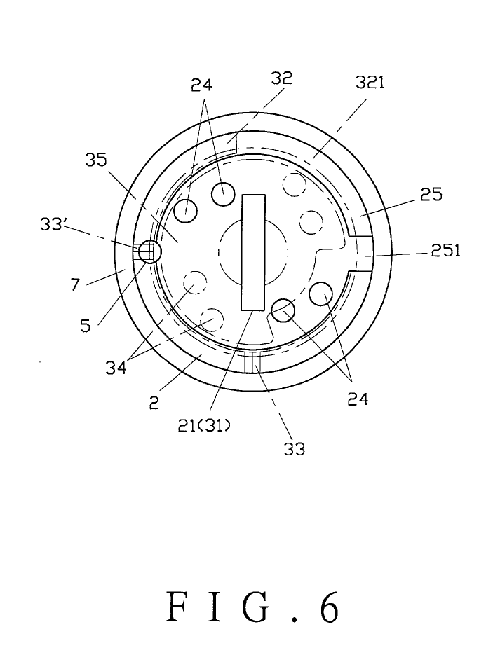

Upon unlocking as illustrated in FIGS. 5 and 6, the unlocking part (61) of the key (6) is attached to the concave (35) of the retainer (3). Since both of said magnets (611) inside the unlocking part (61) and said magnetic pins (24) inside the rotor case cover (2) share the same magnetism, the rejection created forces said magnetic pins (24) protruding into the insertion holes (34) of the retainer (3) retreat into the pinholes (22). As those magnetic pins (24) clear away from the insertion holes (34) of the retainer (3), the retainer (3) is free to rotate as illustrated in FIG. 5. Meanwhile, the unlocking part (61) of the key (6) is completely flush with the concave (35) to simultaneously push the retainer (3) for the gap (321) to rotate in relation to the stopper (251) on the circumference of the rotor case cover (2). The stopper (251) then holds against one edge of the retaining wall (32) to restrict the trip of the retainer (3), which is relocated in position as the positioning bead (5) once again protrudes into the slot (33′) of the retainer (3). Finally, the through hole (31) on the retainer (3) is overlapped with the keyway (21) for the key (6) to be inserted into the keyway (21) to unlock.

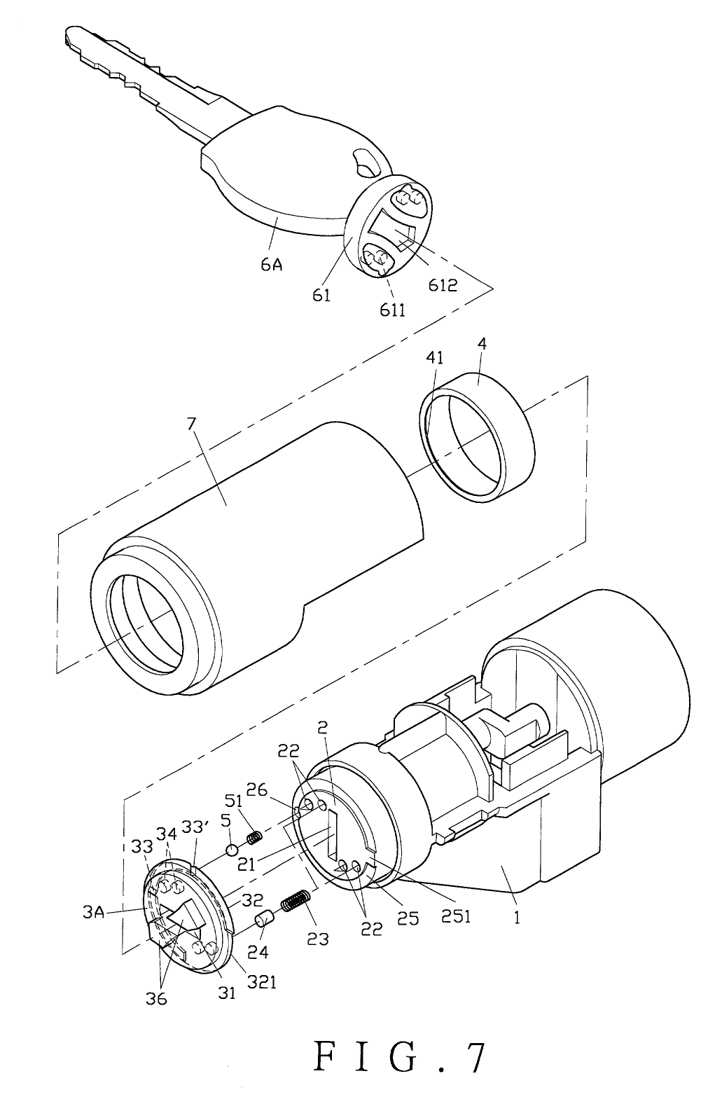

Referring to FIG. 7, a second preferred embodiment of the present invention having the same lockset as that illustrated in the first preferred embodiment, is essentially composed of a rotor (1), a rotor case cover (2), a retainer (3A), a bushing (4), springs (23) and magnetic pins (24) adapted with a key (6A). The rotor case cover (2) is axially provided in the rotor (1), and on the front face of the rotor case cover (2) are provided with a keyway (21) and multiples of pinholes (22) to accommodate the springs (23) and the magnetic pins (24). A guiding channel (25) is provided in recess on the circumference by the side of the rotor case cover (2). A stopper (251) and a positioning hole (26) to allow insertion by a positioning bead (5) and its spring (51). The retainer (3A) following the shape of the rotor case cover (2) relates to a ate having a through hole (31) in relation to the keyway (21) at the center of its front surface and a retaining wall (33) with a gap (321) protrudes from the circumference of the front surface. Two slots (33) and (33′) are provided on the retaining wall (32), and multiples of insertion holes (34) are provided in recess on the retainer (3). The bushing (4) is formed in compromising the shape of the rotor case cover (2), and the circumference of its front end is formed as a retaining ring (41). The stalk of the key (6A) has an unlocking part (61) containing multiples of magnets (611) and the magnetism of those magnets (611) is the same as that of the magnetic pins (24) of the rotor case cover (2) so to reject from each other. The casing (7) is provided to cover up the rotor (1) and those members contained by the rotor (1).

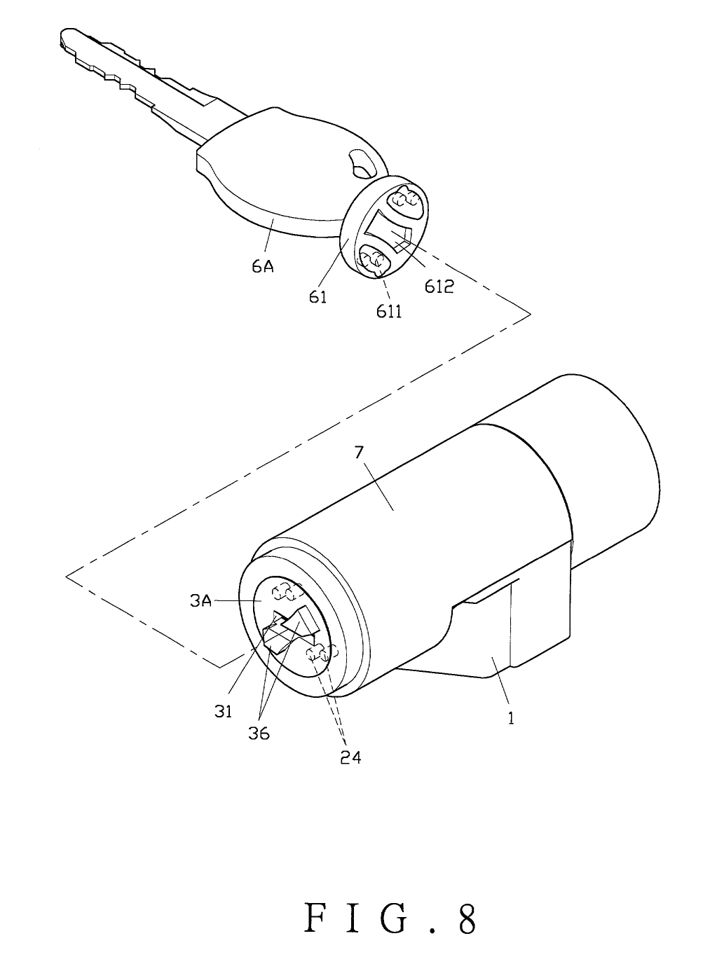

As illustrated in FIG. 8, in the second preferred embodiment a slot (612) is formed on the front surface of the unlocking part (61) of the key (6A) to mate the retainer (3). A corresponding bit (36) separated from the through hole (31) to be inserted into the slot (612) is formed on the outer side of the retainer (3A). The insertion of the bit (36) into the slot (612) constitutes the only direction for combination.

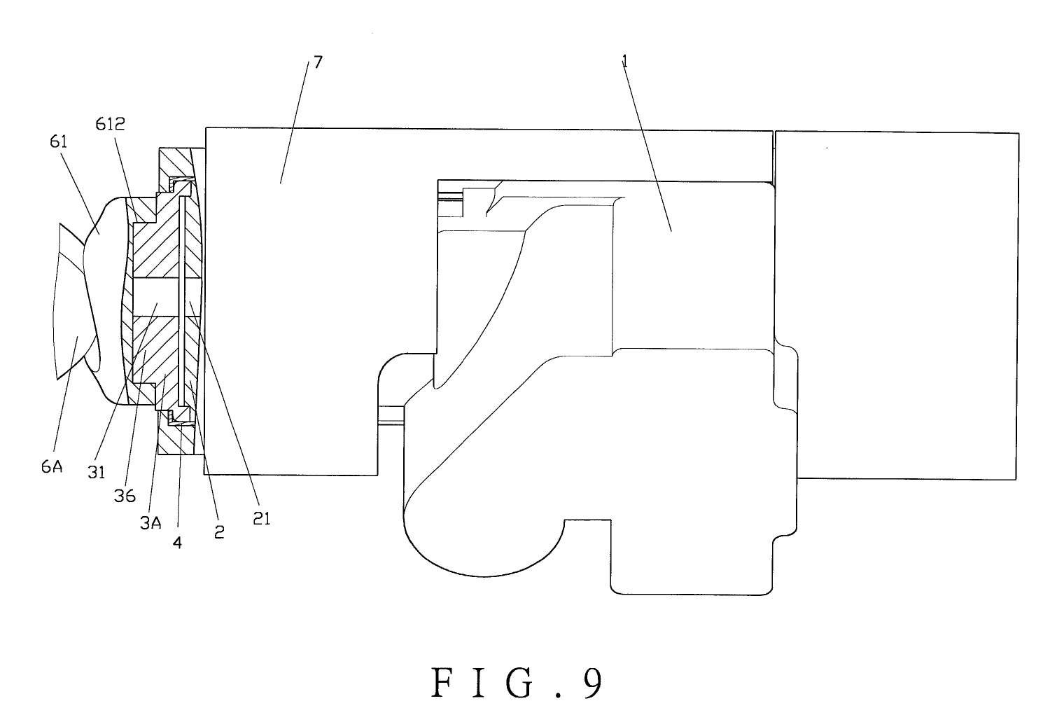

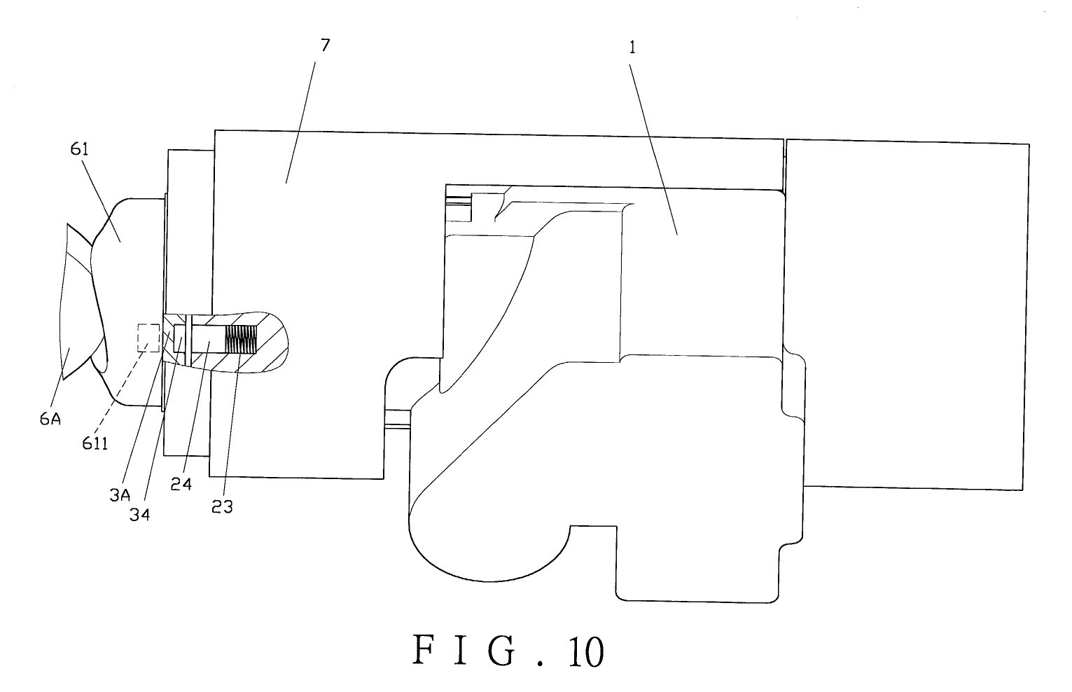

Referring to FIG. 9, the unlocking part (61) of the key (6A) is abutted to the outer side of the retainer (3A) for the slot (612) on the front surface of the unlocking part (61) to receive the insertion of the bit (31) on the outer side of the retainer (3A) in a given direction. Then those magnets (611) inside the unlocking part (61) are located in a position relative to those magnet pins (24) (referring to FIG. 10) to reject those magnetic pins (24). Finally, the unlocking part (61) of the key (6A) to drive the retainer (3A) to rotate until its through hole (31) overlaps with the keyway (21) and the key (6A) is inserted to unlock the lockset.

In the second preferred embodiment, the abutted unlocking structure of the key (6A) is provided on the front face of the unlocking part (61) so that the contour of the appearance of the key (6A) with the unlocking part (61) may be made in any style to allow more options in the design of the appearance of the key (6A). Meanwhile, the bit (36) on the outer side of the retainer (3A) can be made thicker to give better strength fore security purpose.

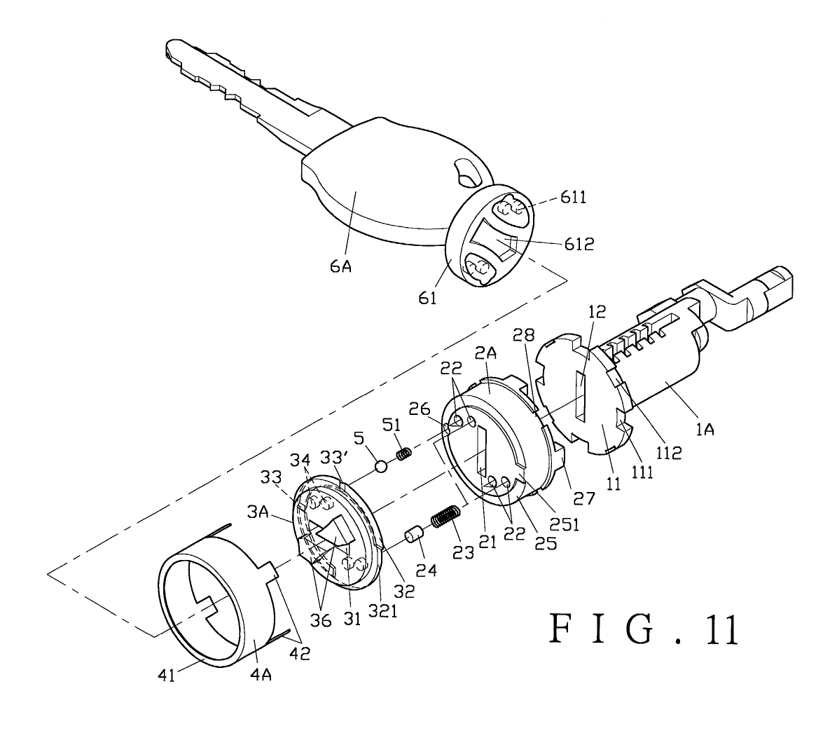

As illustrated in FIG. 11, a third preferred embodiment of the present invention has the similar structure of that of the second preferred embodiment essentially comprising a rotor (1A), a rotor case cover (2A), a retainer (3A), a bushing (4A), springs (23), magnetic pins (24), a positioning bead (5) and its spring (51), and a casing (7) adapted with a key (6A).

The rotor (1A) may be of any configuration and has provided a keyway (12) on its front face (11) and two slots (111) and (112) at equal spacing provided in recess on the circumference of the front face (11). A bit (27) protrudes from the rear end of the rotor case cover (2A) in relation to the slot (111) and another slot (28) is provided in relation to the slot (112). Multiples of tab (42) protrude backward from the circumference of the rear end of the bushing (4A).

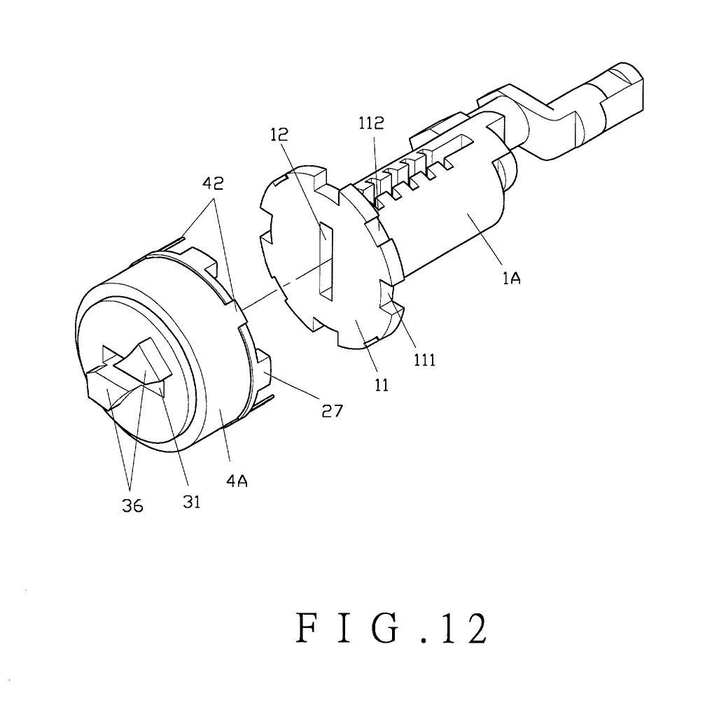

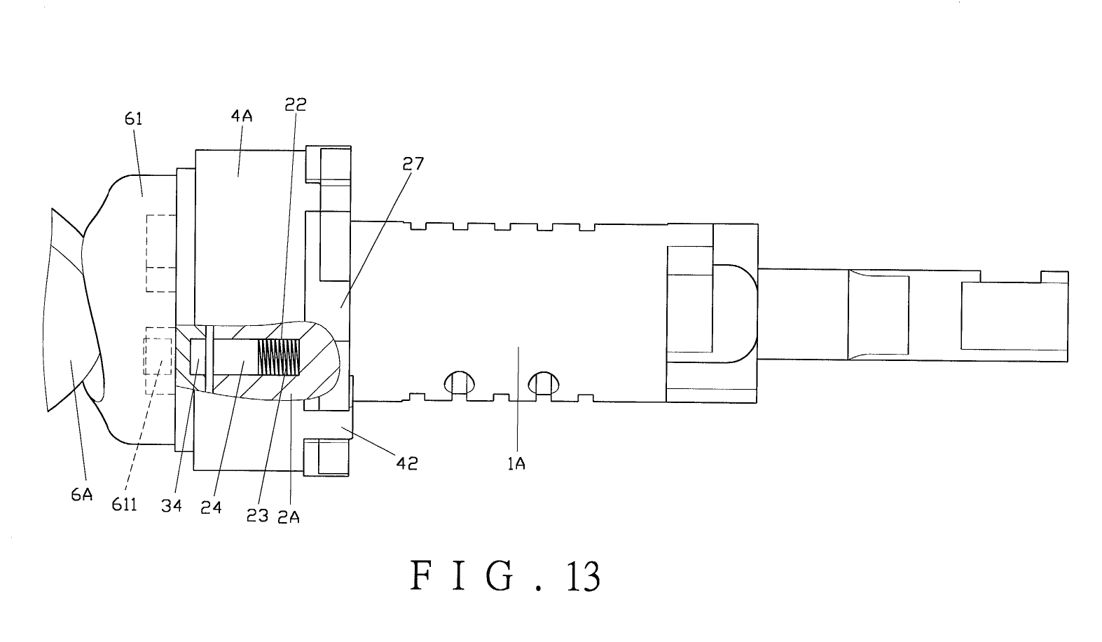

Upon assembling as illustrated in FIGS. 12 and 13 for the third preferred embodiment of the present invention and additional to those are the same for the second preferred embodiment, the bit (27) of the rotor case cover (2A) is inserted into the slot (111) of the rotor (1A) and the bushing (4A) with those extended tabs (42) is inserted into slots (28) and (112), and those tabs (42) are bend and locked to the front face (11) of the rotor (1A). The retainer (3A) then is incorporated to the rotor case cover (2A) to form an independent unit for it to be separately adapted to any type of rotor applied in any type of lockset. In practice, more of said tab (42) may be provided and all the rotor case cover (2A), the retainer (3A), the bushing (4A), the springs (23), those magnetic pins (24) and the positioning bead (5) and its spring (51) may be assembled first to be directly to the lockset depending on the configuration of the front face (11) of the rotor (1A) (generally, such as that round plate as illustrated). In some cases, the slot (112) may be required to be slightly polished. As the working principle of the third preferred embodiment is the same as that described for the first preferred embodiment, therefore, it is not given detailed description for the third preferred embodiment here.

Accordingly, the rotor case cover (2A) and the retainer (3A) of the third preferred embodiment of the present invention are restricted by the bushing (4A) in position to form an independent unit to adapt to any type of rotor in providing the lockset a cover up mechanism for its keyway. It is to be noted that the incorporation of the rotor case cover (2A), the retainer (3A) and the rotor (1A) by means of multiples of tab (42) extending from the bushing (4A) is only a preferred embodiment of the present invention and shall not in any way restrict the present invention.

I claim:

1. A lockset keyway cover-up mechanism including a rotor, a rotor case cover, a retainer, magnetic pins, springs and a casing adapted with a key containing an magnetic unlocking part, the key having an unlocking part containing multiples of magnets with its magnetism the same as that of those magnetic pins on the rotor; the casing related to a hollow one to cover up the rotor and those members described above, characterized by that:
the keyway being provided in the rotor case cover on the front face of the rotor and provided with multiples of pinholes irregularly distributed on the case cover to accommodate the springs and those magnetic pins;
the retainer having provided a through hole in relation to the keyway of the rotor case cover and multiples of insertion hole being provided in relation to those pinholes on the retainer; and
the retainer being provided on the front end of the rotor case cover and covered in position by the casing, the retainer being engaged with its insertion holes to the front face of the rotor case cover and held in position by those magnetic pins in those insertion holes as pushed by the springs, the through hole of the retainer being apart from the keyway, with the unlocking part of the key attached to the retainer, those magnetic pins being rejected by those magnets inside the unlocking part so to clear away from those insertion holes of the retainer for the retainer to engage free rotation, and the through hole of the retainer being overlapped with the keyway.

2. A lockset keyway cover-up mechanism as claimed in claim 1, wherein, the retainer is inserted to the front end of the rotor case cover with a bushing.

3. A lockset keyway cover-up mechanism as claimed in claim 1, wherein, a guiding channel containing a stopper is provided in recess on the circumference on the side of the rotor case cover, and a retaining wait with a gap is provided on the retainer for the gap of the retainer to rotate against the stopper for restricting the travel by the retainer.

4. A lockset keyway cover-up mechanism as claimed in claim 1, wherein, a slot is formed on the unlocking part of the key in relation to the front face of the retainer and a bit is provided on the outer side of the retainer apart from the through hole to be inserted into the slot on the unlocking part of the key so that the insertion of the bit to the slot constitutes the only direction of combination.

5. A lockset keyway cover-up mechanism including a rotor, a rotor case cover, a retainer, magnetic pins, springs and a bushing characterized by that:
the rotor case cover being independently provided on the front end of the rotor, the keyway being provided to the rotor case cover, multiples of positioning bits and matching slots being respectively provided on the rotor case cover and the front face of the rotor;
a through hole being provided on the retainer by compromising the keyway of the rotor case cover;
multiples of tabs extending from the circumference of the bushing to insert into the retainer and the rotor case cover thus to hold the retainer and the rotor case cover in position to form an independent unit before being fixed to the rotor together with the bushing by those tabs extended from the bushing.
